(19) United States
(12) Patent Application Publication
(10) Pub. No.: US 2026/0184135 A1
(43) Pub. Date: Jul. 2, 2026

(54) VEHICLE AIR QUALITY MONITORING AND CONTROL SYSTEM

(71) Applicant: Volvo Car Corporation, Göteborg (SE)

(72) Inventors: Daniel Jared Young, Summerville, SC (US); Derek Boesch, Summerville, SC (US); Andrew Fiorino, Charleston, SC (US); William Figueroa, Summerville, SC (US); Giovanni Spiritoso, Summerville, SC (US); Joshua Ray Crim, Summerville, SC (US); Brian Paul Burgard, Summerville, SC (US); Peter William Barcia, Summerville, SC (US)

(21) Appl. No.: 19/006,803

(22) Filed: Dec. 31, 2024

(51) Int. Cl. B60H 1/00; B60W 10/30; B60W 60/00; E05F 15/71; E05F 15/77

(52) U.S. Cl. CPC B60H 1/008; B60H 1/00821; B60W 60/0016; B60W 10/30; B60W 2540/221; B60W 2555/20; E05F 15/71; E05F 15/77; E05Y 2400/449; E05Y 2900/50

(57) ABSTRACT

Various systems and methods are presented regarding monitoring an operational environment of a vehicle to assist in prevention of injury to a person in, or in the vicinity of, the vehicle and/or components/devices located on the vehicle. An onboard air quality system (AQS) can be configured to receive measurements from sensors onboard, or remotely located to, the vehicle. Measurements can include air quality, chemicals, temperature, etc. The AQS can be configured to implement various actions based on the severity of the respective measurements, such as warn an occupant, cease operation of the vehicle, open/close a window onboard the vehicle, relocate the vehicle, contact emergency services, open/close a garage door, etc. Thresholds can be implemented based on occupant age, occupant health condition, etc.

### TECHNICAL FIELD

This application relates to systems and techniques for monitoring an operational environment of a vehicle regarding health and safety of an entity onboard/in the vicinity of the vehicle and/or operation of the vehicle.

### BACKGROUND

An operational environment can potentially affect operation of a vehicle as well as health and safety of an operator of the vehicle. The operational environment can be affected by fire, heat, fumes (e.g., carbon monoxide (CO), carbon dioxide (CO₂), etc.), pollution, particulates, and the like, whether the source of the fumes, heat, etc., is local to, or remote from, the vehicle. For example, the operational environment can be affected by a vehicle owner/operator accidentally, or intentionally, leaving a vehicle operating with a combustion engine in a closed environment and/or without proper ventilation. Other sources of fumes within a closed/flow-restricted environment of the vehicle (e.g., other vehicles parked/operating nearby) may also increase exterior and/or interior fume levels to undesirable or unsafe levels.

The above-described background is merely intended to provide a contextual overview of some current issues and is not intended to be exhaustive. Other contextual information may become further apparent upon review of the following detailed description.

### SUMMARY

The following presents a summary to provide a basic understanding of one or more embodiments described herein. This summary is not intended to identify key or critical elements, or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented to enable analysis of measurements pertaining to an operational environment of a vehicle and implement one or more actions to mitigate deleterious effects of the operational environment on the health of an entity (e.g., driver, occupant, owner, and the like) or operation of the vehicle.

According to one or more embodiments, a system is presented, wherein the system can be located onboard a vehicle and comprises at least one processor, and at least one memory coupled to the at least one processor and having instructions stored thereon, wherein the system can be configured to monitor air quality of an operating environment of a vehicle, and further control operation of the vehicle based thereon. In response to the at least one processor executing the instructions, the instructions facilitate performance of operations, comprising analyzing a measurement received from a sensor, wherein the sensor is configured to measure an environmental condition pertaining to the vehicle. In an embodiment, the operations can further comprise, based on analysis of the measurement, identifying a threshold pertaining to the measurement, and further, in response to determining the measurement is equal to or exceeds a value defined for the threshold, implementing an action defined for the threshold, wherein the action is configured to mitigate an effect of the environmental condition.

In an embodiment, the sensor can be located onboard the vehicle or can be located remotely from the vehicle.

In another embodiment, the sensor can be located on an interior surface of the vehicle and configured to measure an environmental condition of an interior space of the vehicle or the sensor can be located on an exterior surface of the vehicle and configured to measure an environmental condition of a location of the vehicle.

In an embodiment, the action can be one of close a window located onboard the vehicle, open a window located on board the vehicle, terminate operation of the vehicle, relocate the vehicle, instruct a remotely located door to open, instruct a remotely located door to close, instruct a remotely located window to open, instruct a remotely located window to close, or notify an entity of the environmental condition.

In another embodiment, the environmental condition is represented by one of a chemical, a gas, a liquid, a solid, pollution, a particulate, a pathogen, a pesticide, a perfluoroalkyl substance, and a polyfluoroalkyl substance, a carcinogen, toxic material, radiation, a heat index, or a temperature. In an embodiment, a given amount of the chemical in the environment can be injurious to human health.

In an embodiment, the operations can further comprise receiving a parameter regarding at least one of an age or medical condition of an occupant of the vehicle, further identifying a threshold configured for the at least one of age or medical condition of the occupant, and further implementing the threshold as the threshold against which the measurement analysis is performed.

In an embodiment, the vehicle can be configured to operate autonomously. In an embodiment, the vehicle can be located at a first location and the action comprises automatically relocating the vehicle to a second location, wherein the second location is remote from the first location.

In another embodiment, the action can comprise transmitting an instruction to a system remotely located to the vehicle, wherein the remotely located system is configured to control operation of at least one of a door, a window, a fenestration component, a fan, or a vent, located in a structure at the location at which the vehicle is parked, wherein the instruction is a command for the remotely located system to open or close the door, the window, the fenestration component, or the vent, or a command to start operation of the fan or terminate operation of the fan.

In further embodiments, a computer-implemented method is provided, wherein the method comprises analyzing, by a device comprising at least one processor, a measurement received from a sensor regarding an operational environment of a vehicle, wherein the device is located on the vehicle and the measurement comprises a chemical measurement or a temperature measurement. In an embodiment, the method can further comprise comparing, by the device, the measurement with a threshold, wherein the threshold has a defined action, and further, in response to a determination, by the device, that the measurement exceeds the threshold, implementing the action defined for the threshold, wherein the action is configured to mitigate an effect of the environmental condition.

In another embodiment, the measurement is a first measurement, the threshold is a first threshold, and the action is a first action, wherein the method can further comprise receiving, by the device, subsequent to implementing the first action, a second measurement from the sensor, further comparing, by the device, the second measurement with a second threshold, wherein the second threshold has a defined second action, and the second threshold is disparate to the first threshold, and further, in response to a determination, by the device, that the second measurement exceeds the second threshold, implementing the second action defined for the second threshold.

Further embodiments can include a non-transitory machine-readable medium, comprising executable instructions that, when executed by at least one processor located on a vehicle, facilitate performance of operations, the operations comprising analyzing a measurement received from a sensor, wherein the sensor is configured to measure a condition of an environment pertaining to the vehicle, wherein the environment pertains to a passenger compartment of the vehicle or the environment pertains to an environment external to the vehicle. In a further embodiment, the operations can further comprise, based on analysis of the measurement, identify a threshold having a defined value exceeded by the measurement. In a further embodiment, the operations can further comprise, in response to a determination that the measurement exceeds the value defined for the threshold, implement an action defined for the threshold, wherein the action is configured to mitigate an effect of the environmental condition.

An advantage of the one or more systems, computer-implemented methods and/or computer program products can be to analyze an operational environment (e.g., pertaining to the vehicle, entity, and the like) and implement one or more actions (e.g., based on associated thresholds) to mitigate/prevent any deleterious/potentially deleterious health effects arising from the operational environment with regard to the health of an entity positioned in the operational environment and/or operation of the vehicle.

### DESCRIPTION OF THE DRAWINGS

One or more embodiments are described below in the Detailed Description section with reference to the following drawings.

FIGS. 1A and 1B present various systems/configurations to monitor an operational environment of a vehicle and further respond to a determination of the operational environment is potentially unsafe/is unsafe for a person in the vicinity of the vehicle, operation of the vehicle, etc., in accordance with an embodiment.

FIG. 2 presents a table depicting an example threshold database comprising a series of thresholds and associated actions, in accordance with an embodiment.

FIG. 3A illustrates a flow diagram for a computer-implemented method for mitigating one or more environmental conditions at a location at which a vehicle is located, in accordance with one or more embodiments presented herein.

FIG. 3B illustrates a flow diagram for a computer-implemented method for mitigating one or more environmental conditions at a location at which a vehicle is located based on relocation of vehicle, in accordance with one or more embodiments presented herein.

FIG. 3C illustrates a flow diagram for a computer-implemented method for mitigating one or more environmental conditions at a location at which a vehicle is located based on tiered implementation of thresholds, in accordance with one or more embodiments presented herein.

FIG. 4 illustrates a flow diagram for a computer-implemented method for mitigating one or more environmental conditions at a location at which a vehicle is located and implement an action based on health of an occupant, in accordance with one or more embodiments presented herein.

FIG. 5 illustrates a flow diagram for a computer-implemented method for mitigating one or more environmental conditions at a location at which a vehicle is located, in accordance with one or more embodiments presented herein.

FIG. 6 illustrates a flow diagram for a computer-implemented method for mitigating one or more environmental conditions at a location at which a vehicle is located, in accordance with one or more embodiments presented herein.

FIG. 7 illustrates a flow diagram for a computer-implemented method for mitigating one or more environmental conditions at a location at which a vehicle is located, in accordance with one or more embodiments presented herein.

FIG. 8 is a block diagram illustrating an example computing environment in which the various embodiments described herein can be implemented.

FIG. 9 is a block diagram illustrating an example computing environment with which the disclosed subject matter can interact, in accordance with an embodiment.

FIG. 10 presents a summary of SAE J3016, detailing respective functions and features during Levels 0-5 of driving automation (per June 2018).

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, Abstract, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

As used herein, “data” can comprise metadata. Further, ranges A-n are utilized herein to indicate a respective plurality of devices, components, signals etc., where n is any positive integer.

The operational environment of a vehicle can be deleterious to the health of an entity/person in the vicinity of the vehicle and/or operation of the vehicle itself. For example, CO buildup can be injurious to and even be a cause of death for a person in the vicinity of the vehicle, e.g., where the location of the vehicle does not have sufficient flow of fresh air/oxygen to reduce the CO levels to an acceptable/non-life threatening level. The operating environment can also cause incorrect operation of one or more components, devices, etc., located onboard the vehicle.

Per the various embodiments presented herein, onboard and/or remote sensors can be utilized to sample/monitor the air conditions within/interior to the vehicle (e.g., in the passenger compartment) and exterior to the vehicle (e.g., in a home garage, in a car park, and the like). The one or more sensors can be located in the interior of the vehicle, on an exterior surface of the vehicle, or remotely, e.g., in a building that the vehicle is parked, such as a garage, to detect the level of such fumes within or surrounding a vehicle.

The various embodiments can further include an air quality system (AQS) configured to receive measurements from the one or more sensors, and the AQS can be configured to further compare the measurements with safe/unsafe values, and further determine whether the operational environment is safe/unsafe. Further, the AQS can be configured to utilize artificial intelligence (AI) and machine learning (ML) techniques and technologies to assist in the determination of safe/unsafe operating environment, and effective response thereto.

In an example scenario, a vehicle may be unintentionally left operating in a closed/flow-restricted environment, the AQS can be configured to provide an alert to the owner/operator of the vehicle, e.g., via a mobile device, an application executing on the mobile device, a vehicle-based interface, and the like. Furthering the example, the AQS system can be further configured, based on determining an unsafe operational environment, to selectively or automatically take corrective action, e.g., terminate operation of the vehicle, relocate the vehicle, and the like. As well as monitoring the environment, by terminating operation of the vehicle in a timely manner, the termination can further mitigate/reduce excessive wear or damage to vehicle components caused by unintentionally leaving the vehicle running for a long period of time.

In a further embodiment, the system can be further configured to alert the owner/operator when the environmental conditions (e.g., fume level) within the interior of the vehicle or an immediate surrounding/environment of the vehicle has returned to safe/normal levels.

In an embodiment, a series of operational thresholds can be utilized, e.g., a warning threshold, an action threshold, and the like. In an example scenario, where one or more entities, e.g., occupants, are positioned within a vehicle left running in a closed/flow-restricted environment, the AQS can be configured to provide an alert/warning to the occupant when the interior and/or exterior fume levels are above a first threshold value. In the event of determining concentration of the fumes is rising above a safe fume level/second threshold, the AQS can be configured to, in a non-limiting list: a) automatically stop/terminate operation of the vehicle engine, b) transmit a notification/alert to the occupant, c) establish a communication between the occupant and emergency personnel to enable review of the circumstances, e.g., should a fire service/emergency service be dispatched to the vehicle location, d) establish a communication between the occupant and a crisis service such as a suicide hot-line, e) and suchlike.

In a further embodiment, the respective thresholds can be established for the respective occupant, e.g., based on the occupant's age (baby, child, teenager, adult, senior, and the like), occupant's health concern (asthma, breathing concerns, and the like). The AQS can be further configured to automatically determine one or more of such thresholds based on qualities of the occupant(s) of the vehicle. Rather than a tier of defined thresholds being continually utilized, thresholds can be implemented based on one or more factors regarding a specific instance of operation of the vehicle. For example, where thresholds are implemented based on the occupant, the AQS can be configured to generate and transmit an alert and/or take corrective action at lower fume threshold amount (a first threshold) in the event of an occupant is known/determined to be an infant, child, old, has a pulmonary limitation, and the like. Alternatively, a higher fume threshold (a second threshold) can be utilized for an adult not having a pulmonary condition. In another example embodiment, the AQS can be configured to automatically and/or selectively utilize the engine climate control system to reduce the fume levels within the interior of the vehicle. In another example embodiment of use, in the event of fume levels exterior to the vehicle are lower than inside the vehicle, the AQS can be configured to additionally or alternatively open windows, a sun-roof, etc., to vent the fumes inside the vehicle to the exterior of the vehicle.

In another example embodiment of use, in the event of the fume levels interior and/or exterior to a parked vehicle rise above threshold amounts due to fumes produced by another source (e.g., another vehicle in the vicinity of the vehicle), the AQS can be configured to provide a warning/alert the owner/operator of such unsafe condition. In another example embodiment, the AQS can be configured to provide an update when the fume levels interior/exterior to the vehicle return to normal/safe conditions, indicating the owner/operator may safely approach and/or enter the vehicle. In another example embodiment, the AQS can be configured to warn or alert an operator of the vehicle that an area the driver has parked in, or is about to park in, has fumes over a threshold amount based on measurements from one or more exterior sensor(s) of the vehicle.

In another embodiment, in the event of the vehicle is an autonomous vehicle, AI/ML technologies can be implemented by the AQS to automatically identify an alternate parking location to a current parking location, wherein the alternate parking location has better environmental conditions, e.g., lower fume levels. For example, an interior parking area of an office parking garage has a higher fume concentration than an exterior area.

In another example embodiment, in the event of the vehicle is an autonomous vehicle, in the event of a corrective action, e.g., opening a window, opening a door, alerting the occupant, etc., are not sufficient to reduce the interior fume levels within the vehicle, the AQS can be configured to automatically relocate/move the vehicle from an initial/current location (e.g., a first location) to another location (e.g., a second location) where exterior fume levels/environmental conditions are less hazardous, enabling the interior fume levels to be reduced or vented to the exterior of the vehicle (e.g., exchange of interior air and exterior air). In another example embodiment, the onboard system can be configured to automatically reposition/return the vehicle to the original spot (e.g., the first location) based on measurement and/or prediction (e.g., by a remote sensor, the AI/ML technology, and the like) that, in a non-limiting list, a) the vehicle operator will need the vehicle, b) when instructed by the operator, c) when fume levels at the first location are anticipated to have returned to safe/normal levels (e.g., 30 minutes after a majority of workers sharing a parking garage have vacated the parking garage for the day).

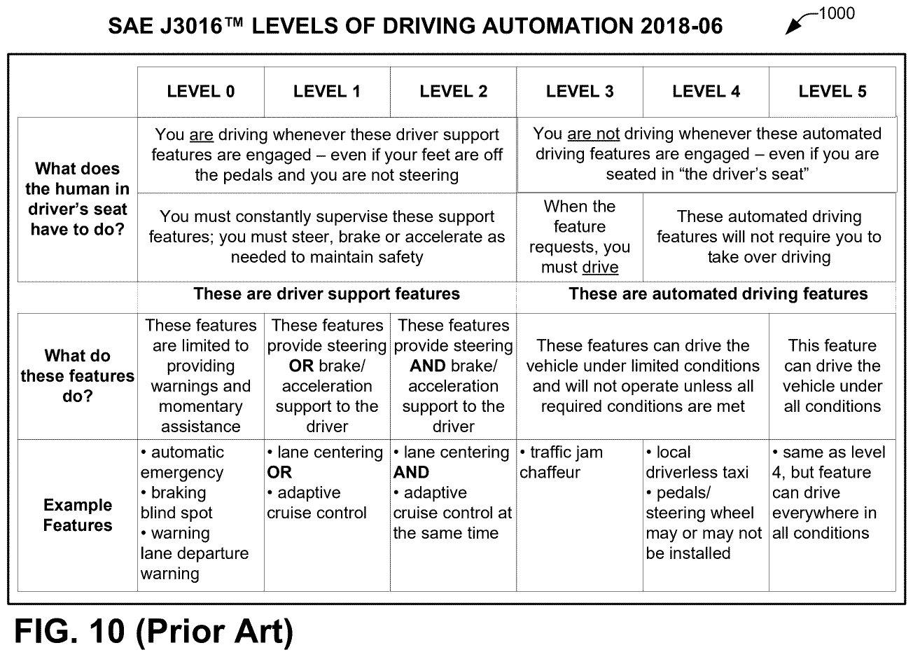

Regarding the phrase “autonomous” operation, to enable the level of sophistication of operation of a vehicle to be defined across the industry by both suppliers and policymakers, standards are available to define the level of autonomous operation. For example, the International Standard J3016 Taxonomy and Definitions for Terms Related to Driving Automation Systems for On-Road Motor Vehicles has been developed by the Society of Automotive Engineers (SAE) and defines six levels of operation of a driving automation system(s) that performs part or all of the dynamic driving task (DDT) on a sustained basis. The six levels of definitions provided in SAE J3016 range from no driving automation (Level 0) to full driving automation (Level 5), in the context of vehicles and their operation on roadways. Levels 0-5 of SAE J3016 are summarized below and further presented in FIG. 10, Table 1000.

Level 0 (No Driving Automation): At Level 0, the vehicle is manually controlled with the automated control system (ACS) having no system capability, the driver provides the DDT regarding steering, braking, acceleration, negotiating traffic, and suchlike. One or more systems may be in place to help the driver, such as an emergency braking system (EBS), but given the EBS technically doesn't drive the vehicle, it does not qualify as automation. The majority of vehicles in current operation are Level 0 automation.

Level 1 (Driver Assistance/Driver Assisted Operation): This is the lowest level of automation. The vehicle features a single automated system for driver assistance, such as steering or acceleration (cruise control) but not both simultaneously. An example of a Level 1 system is adaptive cruise control (ACC), where the vehicle can be maintained at a safe distance behind a lead vehicle (e.g., operating in front of the vehicle operating with Level 1 automation) with the driver performing all other aspects of driving and has full responsibility for monitoring the road and taking over if the assistance system fails to act appropriately.

Level 2 (Partial Driving Automation/Partially Autonomous Operation): The vehicle can (e.g., via an advanced driver assistance system (ADAS)) steer, accelerate, and brake in certain circumstances, however, automation falls short of self-driving as tactical maneuvers such as responding to traffic signals or changing lanes can mainly be controlled by the driver, as does scanning for hazards, with the driver having the ability to take control of the vehicle at any time.

Level 3 (Conditional Driving Automation/Conditionally Autonomous Operation): The vehicle can control numerous aspects of operation (e.g., steering, acceleration, and suchlike), e.g., via monitoring the operational environment, but operation of the vehicle has human override. For example, the autonomous system can prompt a driver to intervene when a scenario is encountered that the onboard system cannot navigate (e.g., with an acceptable level of operational safety), accordingly, the driver must be available to take over operation of the vehicle at any time.

Level 4 (High Driving Automation/High Driving Operation): advancing on from Level 3 operation, while under Level 3 operation the driver must be available, with Level 4, the vehicle can operate without human input or oversight but only under select conditions defined by factors such as road type, geographic area, environments limiting top speed (e.g., urban environments), wherein such limited operation is also known as “geofencing”. Under Level 4 operation, a human (e.g., driver) still has the option to manually override automated operation of the vehicle.

Level 5 (Full Driving Automation/Full Driving Operation): Level 5 vehicles do not require human attention for operation, with operation available on any road and/or any road condition that a human driver can navigate (or even beyond the navigation/driving capabilities of a human). Further, operation under Level 5 is not constrained by the geofencing limitations of operation under Level 4. In an embodiment, Level 5 vehicles may not even have steering wheels or acceleration/brake pedals. In an example of use, a destination is entered for the vehicle (e.g., by a passenger, by a supply manager where the vehicle is a delivery vehicle, and suchlike), wherein the vehicle self-controls navigation and operation of the vehicle to the destination.

To clarify, operations under levels 0-2 can require human interaction at all stages or some stages of a journey by a vehicle to a destination. Operations under levels 3-5 do not require human interaction to navigate the vehicle (except for under level 3 where the driver is required to take control in response to the vehicle not being able to safely navigate a road condition).

As referenced herein, DDT relates to various functions of operating a vehicle. DDT is concerned with the operational function(s) and tactical function(s) of vehicle operation, but may not be concerned with the strategic function. Operational function is concerned with controlling the vehicle motion, e.g., steering (lateral motion), and braking/acceleration (longitudinal motion). Tactical function (aka, object and event detection and response (OEDR)) relates to the navigational choices made during a journey to achieve the destination regarding detecting and responding to events and/or objects as needed, e.g., overtake vehicle ahead, take the next exit, follow the detour, and suchlike. Strategic function is concerned with the vehicle destination and the best way to get there, e.g., destination and way point planning. Regarding operational function, a Level 1 vehicle under SAE J3016 controls steering or braking/acceleration, while a Level 2 vehicle must control both steering and braking/acceleration. Autonomous operation of vehicles at Levels 3, 4, and 5 under SAE J3016 involves the vehicle having full control of the operational function and the tactical function. Level 2 operation may involve full control of the operational function and tactical function but the driver is available to take control of the tactical function.

Accordingly, the term “autonomous” as used herein regarding operation of a vehicle with or without a human available to assist the vehicle in self-operation during navigation to a destination, can relate to any of Levels 1-5. In an embodiment, for example, the terms “autonomous operation” or “autonomously” can relate to a vehicle operating at least with Level 2 operation, e.g., a minimum level of operation is Level 2: partially autonomous operation, per SAE J3016. Hence, while Level 2, partially autonomous operation, may be a minimum level of operation, higher levels of operation, e.g., Levels 3-5, are encompassed in operation of the vehicle at Level 2 operation. Similarly, a minimum Level 3 operation encompasses Levels 4-5 operation, and minimum Level 4 operation encompasses operation under Level 5 under SAE J3016.

It is to be appreciated that while the various embodiments presented herein are directed towards to one or more vehicles (e.g., vehicle 102) operating in an autonomous manner (e.g., as an autonomous vehicle), the various embodiments presented herein are not so limited and can be implemented with a group of vehicles operating in any of an autonomous manner (e.g., Level 5 of SAE J3016), a partially autonomous manner (e.g., Level 1 of SAE J3016 or higher), or in a non-autonomous manner (e.g., Level 0 of SAE J3016). For example, a first vehicle can be operating in an autonomous manner (e.g., any of Levels 3-5), a partially autonomous manner (e.g., any of levels 1-2), or in a non-autonomous manner (e.g., Level 0), while a second vehicle can also be operating in any of an autonomous manner, a partially autonomous manner, or in a non-autonomous manner.

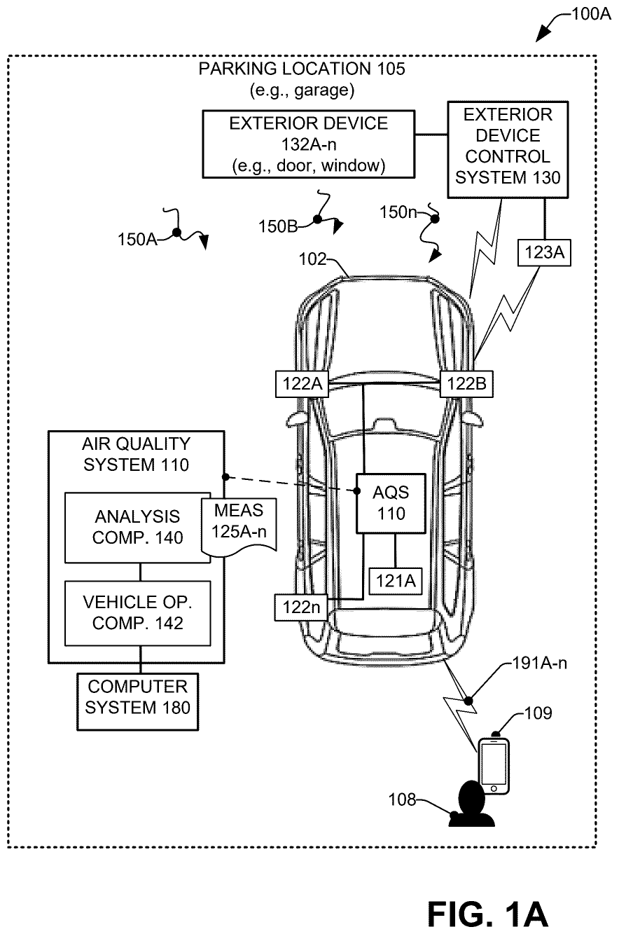

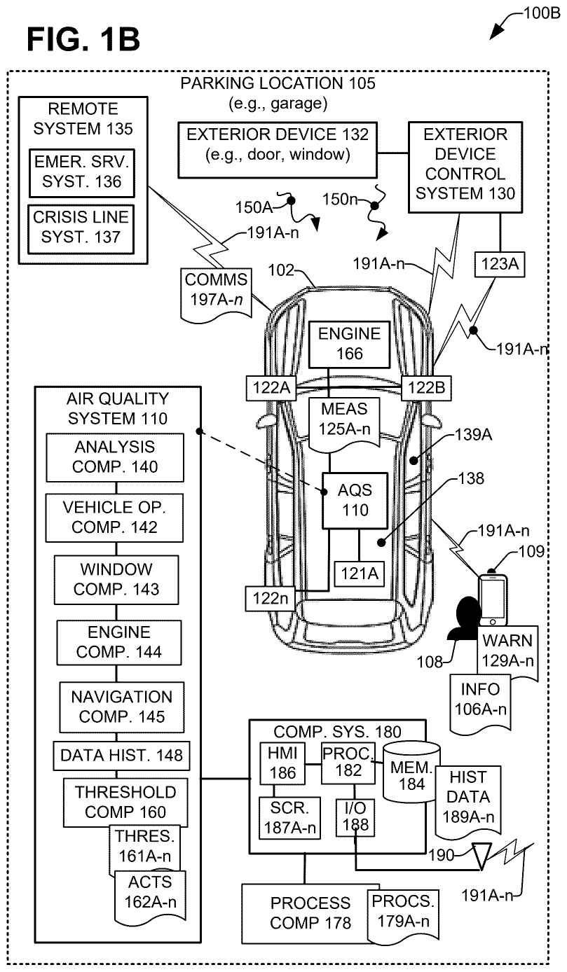

FIG. 1A presents a system 100A, configured to monitor an operational environment of a vehicle and further respond to a determination of the operational environment is unsafe/potentially unsafe for a person in the vicinity of the vehicle, operation of the vehicle, etc., in accordance with an embodiment.

As shown, an air quality system (AQS) 110 is located onboard a vehicle 102, whereby the vehicle 102 is located in a garage 105 (or similar location). One or more sensors 120A-n can be communicatively coupled to the AQS 110, whereby the one or more sensors 120A-n can be configured to provide measurements 125A-n of the operational environment (e.g., gas, CO, CO₂, temperature, and the like, per environmental condition(s) 150A-n) pertaining to operation of the vehicle 102 and/or health of an entity 108 (e.g., owner, operator, occupant, person in the locality of vehicle 102, and the like, wherein the term entity can also pertain to an animal such as a dog, cat, pet, located in or in the vicinity of vehicle 102). While the one or more sensors 120A-n are collectively referenced herein as sensors 120A-n, the one or more sensors 120A-n can comprise any sensor located at any suitable location, e.g., one or more sensors 121A-n located in the passenger cabin space of the vehicle 102, one or more sensors 122A-n located at an exterior surface of the vehicle 102, one or more sensors 123A-n located in a space (e.g., garage 105) where the vehicle 102 is located, and the like. It is to be appreciated that while FIG. 1 presents the environmental condition 150A-n as being exterior to the vehicle 102, the environmental condition 150A-n can also occur within the confines of vehicle 102, e.g., within a passenger compartment located onboard the vehicle 102. Sensors 120A-n can be configured to sense/detect a variety of environmental conditions 150A-n that can be injurious to the health of entity 108A-n and/or operation of vehicle 102 (and one or more components located onboard vehicle 102), such as a chemical, a gas, a liquid, a solid, pollution, particulates, a pathogen, a carcinogen, a pesticide, perfluoroalkyl and polyfluoroalkyl substances (PFAS), toxic material, radiation, heat/temperature (e.g., fumes, heat exhaustion, fire), heat index, environmental hazard, and the like. Measurements 125A-n can be of any suitable measure or magnitude, e.g., a single measure, a concentration, a size, a proportion, a size, a volume, a mass, and the like.

AQS 110 can be further communicatively coupled to an exterior device control system (EDCS) 130, whereby the EDCS 130 can be communicatively coupled to, and further configured to, control operation of an exterior device 132A-n that is located exterior to vehicle 102. The exterior device 132A-n can be any suitable device/structure, such as a garage door, a window, a door, a fenestration component, a fan, a vent, and the like, e.g., located in a structure (e.g., at garage 105) at the location at which the vehicle 102 is parked, and the like, whereby the exterior device 132A-n can be controlled (e.g., opened, closed, turned on, turned off) to enable a change in the operational environment surrounding the vehicle 102. For example, vehicle 102 is located in a garage space 105 having a garage door 132A which can be opened to enable any fumes 150A in the garage space 105 to exit, and fresh air to ingress the garage space 105. Opening of the garage door 132 can be controlled by EDCS 130 in response to an instruction (e.g., in a communication 197A) received from the AQS 110.

AQS 110 can include an analysis component 140 configured to analyze measurements 125A-n from sensors 120A-n regarding environmental condition 150A-n, and further control operation of vehicle 102, control operation of the exterior device 132 (e.g., via EDCS 130), notify an entity 108 (e.g., via a mobile device 109) of the environmental condition 150A-n, and the like, as further described. In an embodiment, analysis component 140 can be configured to analyze/process the measurements 125A-n received from sensors 120A-n. As further described, analysis component 140 can be configured to implement AI & ML technologies and techniques (e.g., per process component 178 and processes 179A-n) to determine the environmental condition 150A-n pertaining to vehicle 102 and/or entity 108.

AQS 110 can further include a vehicle operation component 142, wherein the vehicle operation component 142 can be configured to control (e.g., under instruction of the AQS 110/analysis component 140 in communication 197A-n) one or more devices/components located on board on vehicle 102 (e.g., a window, fan, and the like), and overall operation of vehicle 102 (e.g., vehicle 102 autonomously relocates to another location, cease operation of vehicle 102).

As further shown, AQS 110 can be communicatively coupled to a computer system 180. In an embodiment, computer system 180 can be an onboard vehicle control unit (VCU) configured to control operation of vehicle 102. In an embodiment, computer system 180 can be configured to operate/control/monitor various vehicle operations (e.g., when being operated autonomously, semi-autonomously, window open, window closed, and the like), wherein the various operations can be controlled by the one or more vehicle operation components 142 communicatively coupled to the computer system 180, as further described per FIG. 1B.

Turning to FIG. 1B, system 100B provides further detail regarding the AQS 110 and operation presented in FIG. 1A, in accordance with one or more embodiments.

As previously mentioned, vehicle 102 can include various vehicle operation components 142. The vehicle operation components 142 can include a window component 143 configured to control operation of a window 139A-n located onboard vehicle 102. While the term window 139A-n is utilized, the term window 139A-n includes any suitable component located on board vehicle 102, such as a door, a rear hatch, a sunroof/moonroof, a fenestration component, a component that can be adjusted to enable and/or prevent ingress/egress/exchange of a volume of air/gas from one location (e.g., exterior to vehicle 102) to another location (e.g., an interior of vehicle 102, passenger compartment 138), and the like. In response to a threshold 161A-n (as further described) being exceeded, the window component 143 can be instructed to open the window 139A-n to enable ingress of fresh air into the passenger compartment 138 of vehicle 102. Alternatively, in response to a threshold 161A-n being exceeded, the window component 143 can be instructed to close the window 139A-n to prevent ingress of fumes 150A-n into the passenger compartment 138 of vehicle 102.

Vehicle operation components 142 can further include an engine component 144 configured to control operation of an engine 166 (also a motor or other fume generating device) located onboard vehicle 102. In response to a threshold 161A-n (as further described) being exceeded, the engine component 144 can be instructed to terminate operation of the engine 166, to prevent generation of fumes 150A-n in the parking location 105. Further, the engine component 144 can be configured to terminate operation of the engine 166 in the event of it being inadvertently left running.

Vehicle operation components 142 can further include a navigation component 145 configured to a) identify the current location 105 (first location L₁) of vehicle 102, b) identify an alternate location (second location L₂) potentially having an improved environmental condition 150A-n versus the environmental conditions 150A-n of the current location 105, and c) in the event of vehicle 102 is configured for autonomous/semi-autonomous operation, relocate vehicle 102 from the first location L₁ to the second location L₂, d) in response to an instruction (e.g., in a communication 197A-n), a timing, and the like, relocate vehicle 102 (e.g., from second location L₂ to first location L₁, or from L₂ to a third location L₃. and the like. In response to a threshold 161A-n (as further described) being exceeded, the navigation component 145 can be instructed to perform any of operations (a)-(d), or any other suitable/applicable operation.

AQS 110 can further include a threshold component 160 configured to implement one or more thresholds 161A-n. The one or more thresholds 161A-n can be implemented with associated actions 162A-n, e.g., a first threshold 161A has an associated first action 162A to generate a warning 129A-n, a second threshold 161B can be have an associated second action 162B comprising close a window 139A, relocate the vehicle 102, and the like. Hence, where the environmental condition 150A-n, for example, is a build up of gas (e.g., increasing level of CO), with the first threshold 161A being met/exceeded, a warning 129A-n (e.g., per first defined action 162A) can be transmitted to the mobile device 109 of entity 108, and with the build up of gas continuing to increase such that the second threshold 161B is met/exceeded, the garage door 132 can be opened and vehicle window 139 closed (e.g., per second defined action 162B). Hence, thresholds 161A-n can be utilized by the AQS 110 to respond to a change in measurements 125A-n with associated actions 162A-n in an escalating, or de-escalating, manner to ensure the changing operational environment 150A-n is being addressed with regarding safety of entity 108, operation of the vehicle 102, condition of surroundings/location 105.

As mentioned, AQS 110 can include an analysis component 140, configured to process measurements 125A-n, identify corresponding thresholds 161A-n, and implement actions 162A-n defined for the respective thresholds 161A-n. As further described, any of AQS 110, analysis component 140, threshold component 160, and the like, can be configured to implement artificial intelligence and machine learning (AI & ML) technologies and techniques (e.g., per process component 178 and processes 179A-n) to mitigate an effect of the environmental condition 150A-n on health of entity 108 and/or operation of vehicle 102.

As further shown in FIG. 1B, AQS 110 can be configured to communicate with a remote system 135, wherein the remote system 135 can be operated by any suitable entity. Remote system 135 can comprise an emergency service system 136, e.g., fire service, medical, etc., enabling personnel at the emergency service system 136 to review conditions at the location 105/vehicle 102/occupant 108, etc., to determine whether an emergency service be dispatched to the vehicle location 105. Remote system 135 can comprise a crisis hotline system 137 (e.g., a suicide hot-line), enabling personnel at the crisis hotline system 137 to review conditions at the location 105/vehicle 102/occupant 108, etc., to determine whether communication (e.g., via mobile device 109) the should be initiated with entity 108 by an entity at the crisis hotline system 137, e.g., to prevent a potential self-harm by occupant 108.

As shown in FIG. 1B, a computer system 180 can be communicatively coupled to/included in the AQS 110. Computer system 180 can include at least one memory 184A-n that stores the respective computer executable components (e.g., AQS 110, analysis component 140, vehicle operation component 142, window component 143, engine component 144, navigation component 145, data historian 148, process component 178, threshold component 160, and suchlike), and further, at least one processor 182A-n configured to execute the computer executable components stored in the memory 184. Memory 184 can be further configured to store/include occupant information 106A-n, thresholds 161A-n, actions 162A-n, measurements 125A-n, communications 197A-n, processes 179A-n, locations L₁₋ₙ of vehicle 102, threshold database 200, and further, historical data 189A-n, wherein historical data 189A-n can include any previously/current/future defined/identified/processed measurements 125A-n, vectors V₁₋ₙ, similarity indexes S₁₋ₙ, and suchlike.

The computer system 180 can further include a human machine interface (HMI) 186 (e.g., a display, a graphical-user interface (GUI), infotainment system) which can be configured to present various information regarding any of prior/current measurements 125A-n, thresholds 161A-n, actions 162A-n, communications 197A-n, processes 179A-n, and further, historical data 189A-n, etc., per the various embodiments presented herein. HMI 186 can include an interactive display 187A-n to present the various information via various screens presented thereon, and further configured to facilitate input of information/settings/selections, etc., regarding operation of the vehicle 102. In an example embodiment, HMI 186 and screens 187A-n can present an audible/visible warning/alarm 129A-n (e.g., per action 162A-n) regarding potentially unsafe/unsafe environmental condition 150A-n, operations of windows 139A-n, exterior device 132A-n, relocation of vehicle 102, and the like. Similar interaction/screens can be provided to an entity 108 via an application operating on the mobile device 109.

In an embodiment, in the event that vehicle 102 is being operated in an autonomous manner (e.g., Level 5 of SAE J3016), notification communications 197A-n can be utilized to present a warning 129A-n on the HMI 186 and screen 187A-n to notify an occupant 108 of vehicle 102 that vehicle 102 is being automatically/autonomously relocated to an alternate location.

As further shown, the computer system 180 can include an input/output (I/O) component 188, wherein the I/O component 188 can be a transceiver configured/communicatively coupled to enable transmission/receipt (via antenna 190) of signals 191A-n, position information L₁₋ₙ, communications 197A-n, and suchlike, between the AQS 110/computer system 180 and any external system(s), e.g., EDCS 130, remote system 135. Any suitable technology can be utilized to enable the various embodiments presented herein, regarding transmission and receiving of signals 191A-n. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

It is to be appreciated that while the term “communication” is presented herein with regard to communications 197A-n, the content of a communication 197A-n can include a notification, data, information, instruction, request, response, warning (e.g., warning 129A-n), measurements 125A-n, an action 162A-n, occupant information 106A-n, and suchlike, and further the communications 197A-n can be generated, transmitted, and/or received by any of the components (e.g., in AQS 110) located and operating onboard vehicle 102, and between any vehicle 102, EDCS 130, remote system 135, emergency service system 136, crisis hotline system 137, and the like. The respective components are configured to analyze, generate, act upon, transmit, and receive information/data/communications 197A-n between the components (e.g., AQS 110 and subcomponents), and further, to EDCS 130, emergency service system 136, crisis hotline system 137, and the like.

AQS 110 can also include a data historian 148 configured to generate/update historical data 189A-n with any information regarding current/prior measurements 125A-n, occupant information 106A-n, current/prior thresholds 161A-n, current/prior actions 162A-n, similarity indexes S₁₋ₙ, vectors Vn, and suchlike. Historical data 189A-n can be utilized by a process component 178/one or more AI/ML processes 179A-n, etc., to determine an environmental condition 150A-n present at vehicle 102 and according action 162A-n to implement, e.g., in conjunction with a threshold 161A-n (either defined or inferred).

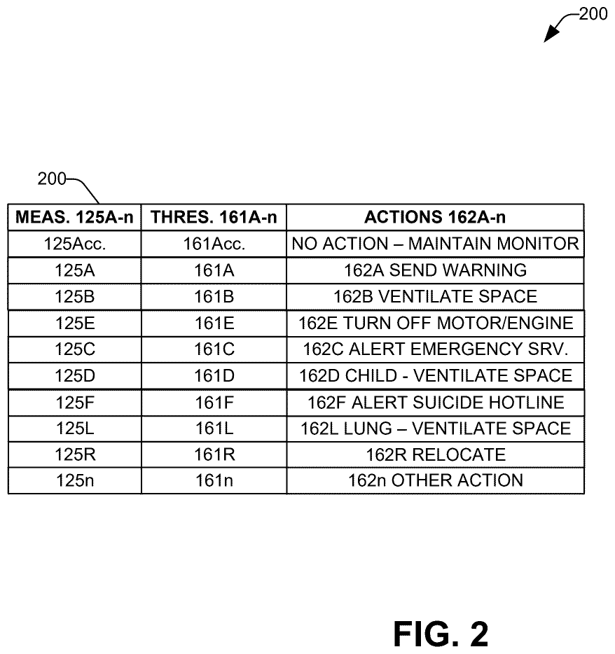

Turning to FIG. 2, Table 200 presents an example threshold database comprising a series of thresholds and associated actions, in accordance with an embodiment. As mentioned, the analysis component 140 can be configured to monitor measurements 125A-n in conjunction with thresholds 161A-n, and implement actions 162A-n in response to the analysis component 140 determining, in response to a respective measurement 125A-n, that a respective threshold 161A-n has been met/exceeded. Analysis component 140 can be further configured to monitor a sequence of measurements 125A-n and thresholds 161A-n being implemented, such that as conditions 150A-n return to an acceptable level, further actions 162A-n can be implemented. For example, with initial conditions 150A-n being at an acceptable level, measurements 125A-n are at or below acceptable measurement 125Acc./threshold 161Acc., no actions 162A-n are implemented, and monitoring is maintained. As conditions 150A-n become worse (e.g., measurement 125B>measurement 125A>measurement 125Acc.) the corresponding thresholds 161A-n are triggered with associated actions 162A-n implemented. In the event of the severity of conditions 150A-n improves, contrary actions can be implemented, e.g., while measurement 125n is above threshold 161n, vehicle 102 is relocated to an alternate location, and in the event of measurements 125A-n drop below threshold 161n, analysis component 140 can be configured to return vehicle 102 to the initial location, as required. Hence, while the actions 162A-n present a specific action (e.g., open garage door 132A, relocate vehicle 102, and the like), as conditions at a location improve, an alternate action 162A-n can be implemented, such as close garage door 132A, relocate vehicle 102 to original location, and the like.

In an example scenario, where one or more entities 108A-n are positioned within a vehicle 102 left running in a closed/flow-restricted environment, AQS 110 can be configured to provide an alert/warning 129A-n to the entity 108A-n (e.g., via mobile device 109, HMI 186) when the interior and/or exterior fume levels (e.g., per measurements 125A-n) are above a first threshold value 161A. In the event of AQS 110 further determining concentration of the fumes is rising above a safe fume level/second threshold, AQS 110 can be configured to, in a non-limiting list: a) automatically stop/terminate operation of the engine 166 located onboard vehicle 102, b) transmit a notification/alert to the entity 108A-n, c) establish a communication 197A-n between the entity 108A-n and emergency service system 136 to enable review of the circumstances, e.g., should a fire service/emergency service be dispatched to the vehicle location (e.g., garage 105 at location L₁), d) establish a communication 197A-n between the entity 108 and a crisis service system 137 such as a suicide hot-line, e) and suchlike.

In a further embodiment, the respective thresholds 161A-n can be established for the respective entity 108A-n, e.g., based on the entity's age (baby, child, teenager, adult, senior, and the like), entity's health concern (asthma, breathing concerns, and the like). AQS 110 can be further configured to determine one or more of such thresholds 161A-n based on health/physical qualities of the entity(ies) 108 of the vehicle 102. Rather than a tier of defined thresholds 161A-n being continually utilized, thresholds 161A-n can be implemented based on one or factors regarding a specific instance of operation of the vehicle. For example, thresholds 161A-n can be implemented based on the entity 108, e.g., age, health condition, and the like. In an embodiment, AQS 110 can be configured to generate and transmit an alert 129A-n and/or take corrective action 162A-n at lower fume threshold amount (a first threshold 161A) in the event of an entity 108 is known/determined to be an infant, child, old, has a pulmonary limitation, and the like. Alternatively, a higher fume threshold (a second threshold 161B) can be utilized for an adult not having a pulmonary condition. In another example embodiment, the AQS 110 can be configured to automatically and/or selectively utilize the vehicle climate control system to reduce the fume levels within the interior 138 of the vehicle. In another example embodiment of use, in the event of fume levels exterior to the vehicle 102 are lower than inside 138 the vehicle 102, AQS 110 can be configured to additionally or alternatively open windows 139A-n, a sun-roof, etc., to vent the fumes inside the vehicle 102 to the exterior of the vehicle 102.

In another example embodiment of use, in the event of the fume levels 150A-n interior and/or exterior to a parked vehicle 102 rise above threshold amounts 161A-n due to fumes produced by another source (e.g., another vehicle in the vicinity of vehicle 102), AQS 110 can be configured to provide a warning/alert 129A-n to entity 108 of such unsafe condition 150A-n. In another example embodiment, AQS 110 can be configured to provide an update when the fume levels 150A-n interior/exterior to the vehicle 102 return to normal/safe conditions, indicating entity 108 may safely approach and/or enter the vehicle 102. In another example embodiment, AQS 110 can be configured to warn or alert 129A-n entity 108 that an area vehicle 102 has been parked, or is about to park in, has fumes 150A-n over a threshold amount 161A-n based on measurements 125A-n from one or more exterior sensor(s) 122A-n/123A-n of the vehicle 102.

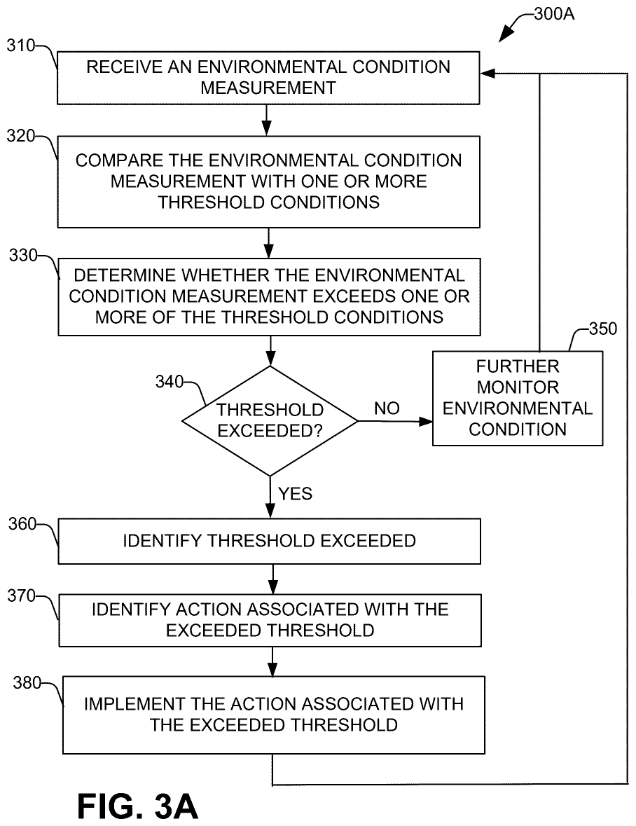

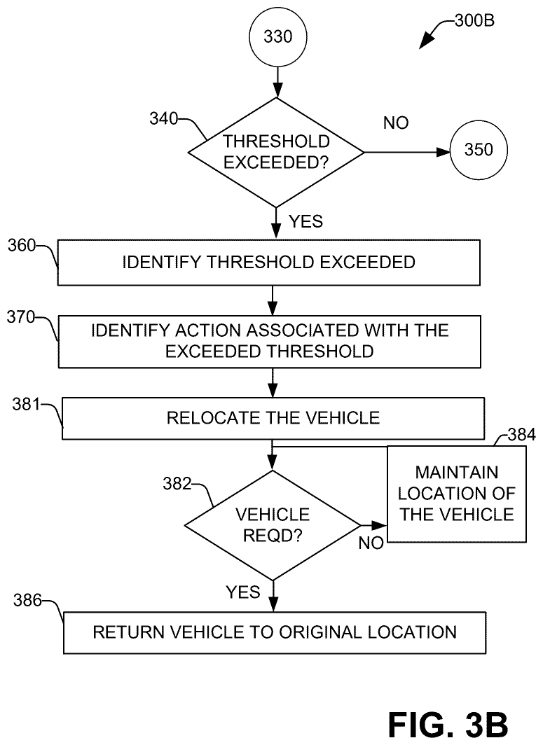

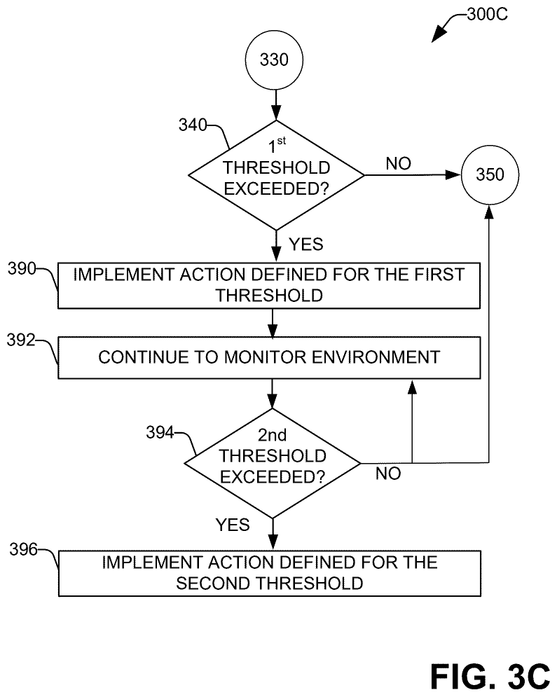

FIGS. 3A-3C, via flowcharts 300A-C, present example computer-implemented methods to monitor an operational environment and implement an action based thereon, in accordance with an embodiment.

Regarding FIG. 3A, at 310, a measurement (e.g., measurement 125A-n) can be received at an air quality analysis system (e.g., AQS 110), wherein the measurement is received from a sensor (e.g., sensor 120A-n) configured to measure air quality at a location (e.g., in garage 105) where a vehicle (e.g., vehicle 102) is located. The measurement corresponds to an environmental condition (e.g., condition 150A-n) at the location.

At 320, the measurement can be compared (e.g., by AQS 110, analysis component 140, threshold component 160) with one or more thresholds (e.g., thresholds 161A-n in threshold database 200) configured for implementation regarding the environmental condition of the location.

At 330, a determination can be made (e.g., by AQS 110, analysis component 140, threshold component 160) regarding whether the measurement matches or exceeds one or more of the threshold conditions.

At 340, in response to a determination (e.g., by AQS 110, analysis component 140, threshold component 160) that NO, the measurement does not match or exceed a threshold (e.g., measurement 125A-n is at an acceptable level, e.g., measurement 125Acc. and is below any of the thresholds), method 300A can advance to step 350 for further monitoring by the AQS of the environmental condition at the location, with method 300A returning to step 310, for subsequent monitoring of the location.

At 340, in response to a determination (e.g., by AQS 110, analysis component 140, threshold component 160) that YES, the measurement matches or exceeds a threshold, method 300A can advance to step 360, whereupon the threshold associated with the measurement can be identified (e.g., environmental condition at garage 105 means value of measurement 125A matches/exceeds the defined value of the threshold 161A).

At 370, for the respective threshold that has been identified as being matched and/or exceeded, an action (e.g., action 162A-n) defined for the matched/exceeded threshold can be identified (e.g., action 162A defined for threshold 161A).

At 380, the identified action can be implemented. Upon implementation of the identified action, method 300A can return to step 310 for further monitoring of the operational environment at the vehicle location.

Turning to FIG. 3B, computer-implemented method 300B is presented regarding relocation of vehicle 102. At 340, in response to a determination (e.g., by AQS 110, analysis component 140, threshold component 160) that NO, the measurement does not match or exceed a threshold (e.g., measurement 125A-n is at an acceptable level, e.g., measurement 125Acc. and is below any of the thresholds), method 300B can advance to step 350.

At 340, in response to a determination (e.g., by AQS 110, analysis component 140, threshold component 160) that YES, the measurement matches or exceeds a threshold, method 300B can advance to step 360, whereupon the threshold associated with the measurement can be identified (e.g., environmental condition at garage 105 means value of measurement 125A matches/exceeds the defined value of the threshold 161A). In an example embodiment, the exceeded threshold (e.g., threshold 161R) can pertain to the location of the vehicle, e.g., the vehicle is located at a first location L₁ (e.g., garage 105).

At 370, with the threshold being identified as being matched and/or exceeded, an action (e.g., action 162A-n) defined for the matched/exceeded threshold can be identified (e.g., action 162R defined for threshold 161R). In the example embodiment presented in FIG. 3B, the action can be relocation of the vehicle from the current/first location L₁ (e.g., garage 105) to an alternate/second location L₂ (e.g., remote from garage 105).

At 381, the relocation action can be implemented. As mentioned, the vehicle can be configured to operate autonomously, whereby, with implementation of the relocation action, the vehicle autonomously relocates from location L₁ to location L₂.

At 382, monitoring of the environmental conditions at the initial location (e.g., garage 105) can be further monitored. In the event of the environmental conditions are acceptable (e.g., now below threshold 161R), it is possible for the vehicle to be configured to autonomously return from current location L₂ to original location L₁. In an alternative embodiment, the vehicle can be configured to remain at the current location L₂ until required at the original location L₁, e.g., in response to a signal from the operator (e.g., owner 108 via mobile device 109). In response to a determination that NO instruction has been received regarding the current location of the vehicle, method 300B can advance to 384 with the vehicle remaining at the current location L₂. Method 300B can further return to step 382 to await subsequent instruction regarding subsequent operational need/location of the vehicle.

At 382, in response to YES, an instruction (e.g., in a communication 197A-n from mobile device 109) has been received indicating the vehicle is required at the first location L₁, method 300B can advance to step 386. In an embodiment, rather than the vehicle awaiting an instruction from the operator (e.g., owner 108), the relocation can be based on any suitable configuration, e.g., a time at which the operator is known to leave a location, e.g., an office, as programmed into the AQS 110 via HMI 186, for example.

At step 386, the vehicle can autonomously relocate to the first location L₁.

Turning to FIG. 3C, computer-implemented method 300C is presented regarding tiered implementation of thresholds 161A-n. At 340, in response to a determination (e.g., by AQS 110, analysis component 140, threshold component 160) that NO, the measurement does not match or exceed a threshold (e.g., measurement 125A-n is at an acceptable level, e.g., measurement 125Acc. and is below any of the thresholds), method 300C can advance to step 350.

At 340, in response to a determination (e.g., by AQS 110, analysis component 140, threshold component 160) that YES, the measurement matches or exceeds a threshold, method 300C can advance to step 390. In an embodiment, the exceeded threshold can be a first threshold in a series of thresholds, wherein the respective thresholds in the series of thresholds are configured to implement escalating levels of action in response to environmental conditions at the vehicle location worsening. Accordingly, at 340, the exceeded threshold is a first threshold, with method 300C advancing to step 390.

At 390, an action (e.g., first action 162A) defined for the first threshold can be implemented. For example, the action can be generate a warning 129A-n on any of the user device (e.g., mobile device 109), on the onboard user interface (e.g., HMI 186), to a person associated with the entity (e.g., a person (not shown) associated with the entity 108, e.g., a parent of child 108), and the like.

At 392, the operational environment can be continued to be monitored, e.g., in part to assess the effect of the first action on the operational environment.

At 394, in response to a determination (e.g., by AQS 110, analysis component 140, threshold component 160) that the operational environment was positively affected (e.g., a second threshold was NOT exceeded) by the first action (e.g., CO levels are stable, reducing) method 3C can return to step 392 for further monitoring of the conditions with regard to the second threshold, and further, in response to the conditions are reduced to below an earlier threshold amount, method 300C can further return to step 350.

At 394, in response to a determination (e.g., by AQS 110, analysis component 140, threshold component 160) that a second threshold has been exceeded, e.g., the operational environment has not been positively affected by the first action (e.g., CO levels are still increasing) method 3C can advance to step 396, whereupon a second action (e.g., establish communication between mobile device 109/HMI 186 and an external system 135 hosting a suicide prevention crisis phoneline 137/emergency service 136, relocate vehicle 102, terminate operation of a motor/engine 166 onboard the vehicle 102, and the like).

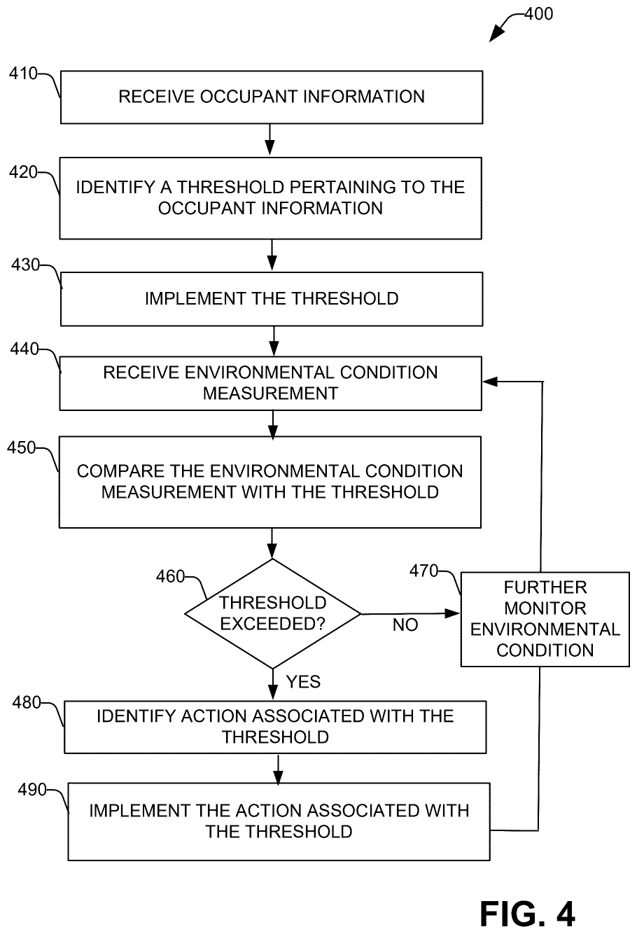

FIG. 4, via flowchart 400, presents an example computer-implemented method to monitor an operational environment and implement an action based thereon regarding health of an occupant, in accordance with an embodiment.

At 410, information (e.g., entity information 106A-n) regarding an occupant (e.g., person 108) of a vehicle (e.g., vehicle 102), or in the vicinity of the vehicle, can be received at an air quality system (e.g., AQS 110). The occupant information can comprise of any suitable information to facilitate establishment and/or comparison of an environmental condition (e.g., per measurements 125A-n) with a threshold (e.g., thresholds 161A-n) regarding health and safety of the occupant. For example, occupant information can define the occupant as a child, as a person having a lung condition, a medical condition, a health condition, and the like. Any suitable means can be utilized to enter the occupant information, e.g., via an onboard interface (e.g., HMI 186), via communication with a health tag/mobile device (e.g., mobile device 109), and the like.

At 420, a threshold pertaining to the occupant information can be identified (e.g., by AQS 110, analysis component 140, threshold component 160). For example, a child health threshold (e.g., threshold 161D), a breathing issue threshold (e.g., threshold 161L), and the like. A sequence of thresholds can be implemented, such that as the environmental condition worsens, escalating actions (e.g., actions 162A-n) can be implemented.

At 430, the identified threshold can be implemented for comparison with an environmental condition (e.g., by AQS 110, analysis component 140, threshold component 160).

At 440, an environmental condition measurement (e.g., measurement 125A-n) can be received (e.g., at AQS 110) from a sensor (e.g., sensor 120A-n) communicatively coupled thereto.

At 450, an environmental condition (per measurement 125A-n) obtained at the vehicle location (e.g., garage 105) can be compared (e.g., by AQS 110, analysis component 140, threshold component 160) with the one or more thresholds (e.g., thresholds 161A-n in threshold database 200) configured for implementation regarding the environmental condition of the location.

At 460, in response to a determination (e.g., by AQS 110, analysis component 140, threshold component 160) that NO, the environmental condition does not match and/or exceed the occupant threshold (e.g., measurement 125A-n is at an acceptable level, e.g., measurement 125Acc. and is below threshold 161D), method 400 can advance to step 470 for further monitoring by the AQS of the environmental condition at the location, with method 400 returning to step 440, for subsequent monitoring of the location.

At 460, in response to a determination (e.g., by AQS 110, analysis component 140, threshold component 160) that YES, the environmental condition matches or exceeds the occupant threshold, method 400 can advance to step 480, whereupon the action (e.g., action 162D) associated with the threshold can be identified (e.g., environmental condition at garage 105 means value of measurement 125D matches/exceeds the defined value of the threshold 161D).

At 490, the action defined for the occupant threshold can be implemented. Upon implementation of the identified action, method 400 can return to step 440 for further monitoring of the operational environment at the vehicle location.

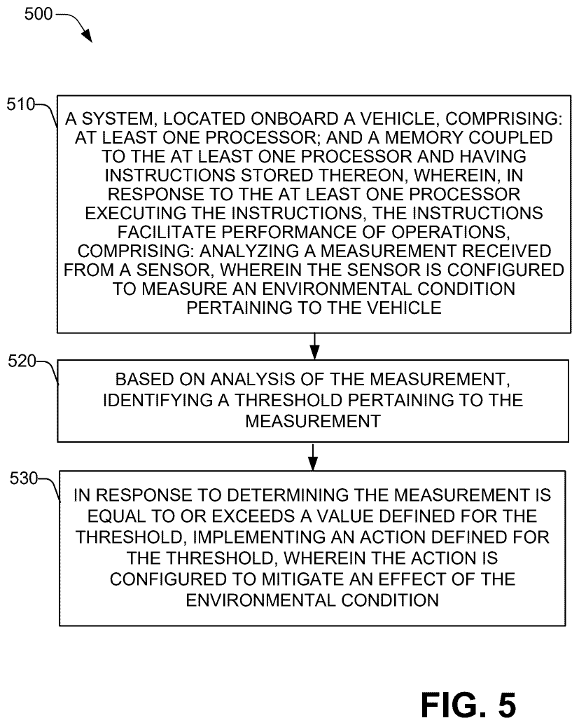

FIG. 5, via flowchart 500, presents a computer-implemented method for mitigating one or more environmental conditions at a location at which a vehicle is located, in accordance with one or more embodiments presented herein.

At 510, method 500 can utilize a system (e.g., AQS 110) located onboard a vehicle (e.g., vehicle 102), wherein the system can comprise at least one processor (e.g., processor 182A-n) and a memory (e.g., memory 184A-n) coupled to the at least one processor and having instructions stored thereon, wherein, in response to the at least one processor executing the instructions, the instructions facilitate performance of operations, comprising analyzing a measurement (e.g., measurement 125A-n) received from a sensor (e.g., sensor 120A-n), wherein the sensor is configured to measure an environmental condition (e.g., environmental condition 150A-n) pertaining to the vehicle.

At 520, method 500 can further comprise an operation, based on analysis (e.g., by AQS 110) of the measurement, identifying (e.g., by AQS 110) a threshold (e.g., a threshold 161A-n) pertaining to the measurement.

At 530, method 500 can further comprise an operation, in response to determining (e.g., by AQS 110) the measurement is equal to or exceeds a value defined for the threshold, implementing an action (e.g., action 162A-n) defined for the threshold, wherein the action is configured to mitigate an effect of the environmental condition.

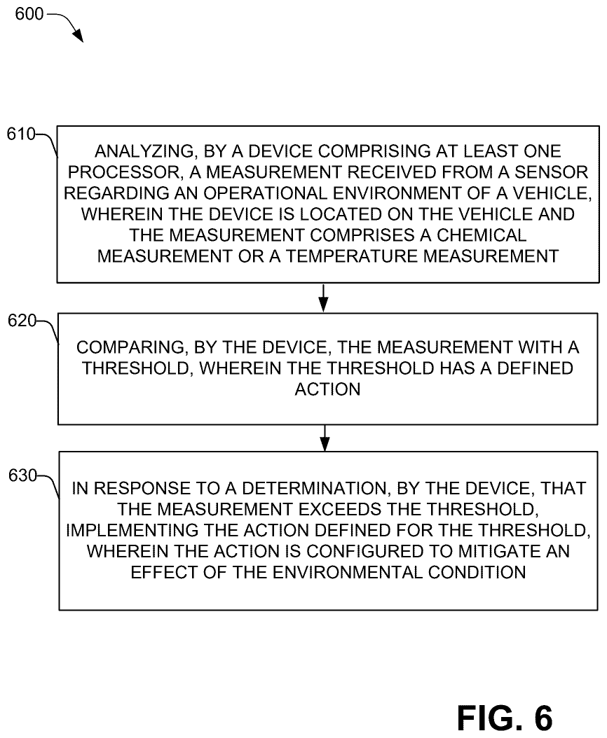

FIG. 6, via flowchart 600, presents a computer-implemented method for mitigating one or more environmental conditions at a location at which a vehicle is located, in accordance with one or more embodiments presented herein.

At 610, the process 600 can comprise analyzing, by a device (e.g., AQS 110) comprising at least one processor (e.g., processor 182A-n), a measurement (e.g., a measurement 125A-n) received from a sensor (e.g., sensor 120A-n) regarding an operational environment (e.g., operational condition 150A-n) of a vehicle (e.g., vehicle 102), wherein the device is located on the vehicle and the measurement comprises a chemical measurement or a temperature measurement.

At 620, the process 600 can further comprise comparing, by the device, the measurement with a threshold (e.g., a threshold 161A-n), wherein the threshold has a defined action (e.g., an action 162A-n).

At 630, the process 600 can further comprise, in response to a determination, by the device, that the measurement exceeds the threshold, implementing the action defined for the threshold, wherein the action is configured to mitigate an effect of the environmental condition.

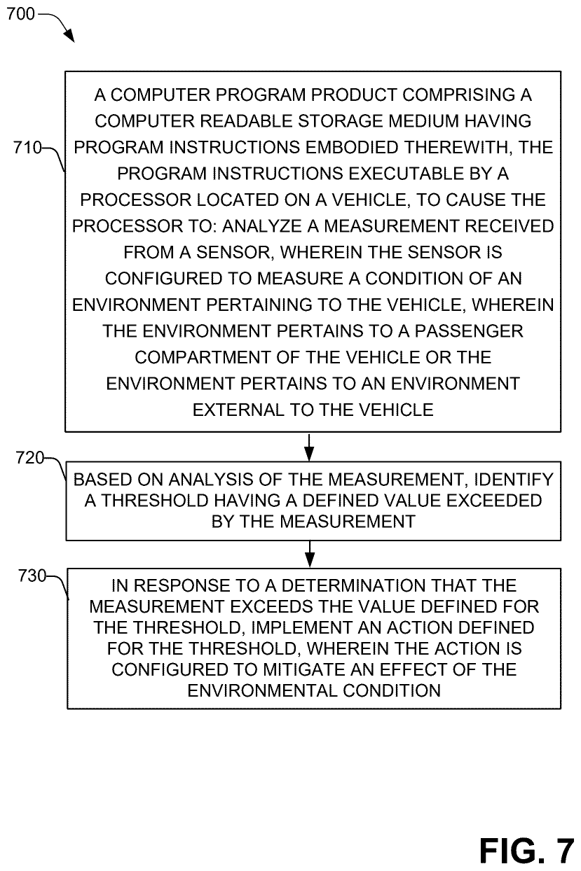

FIG. 7, via flowchart 700, presents a computer-implemented method for mitigating one or more environmental conditions at a location at which a vehicle is located, in accordance with one or more embodiments presented herein.

At 710, process 700 can comprise a computer program product (e.g., AQS 110) comprising a computer readable storage medium (e.g., memory 184A-n) having program instructions embodied therewith, the program instructions executable by a processor (e.g., processor 182A-n) located on a vehicle (e.g., vehicle 102), to cause the processor to analyze a measurement (e.g., measurement 125A-n) received from a sensor (e.g., sensor 120A-n), wherein the sensor is configured to measure a condition (e.g., condition 150A-n) of an environment pertaining to the vehicle, wherein the environment pertains to a passenger compartment of the vehicle or the environment pertains to an environment external to the vehicle.

At 720, process 700 can further comprise, based on analysis of the measurement, identify a threshold (e.g., threshold 161A-n) having a defined value exceeded by the measurement.

At 730, process 700 can further comprise, in response to a determination that the measurement exceeds the value defined for the threshold, implement an action (e.g., action 162A-n) defined for the threshold, wherein the action is configured to mitigate an effect of the environmental condition.

### Application/Implementation of AI & ML

As mentioned, the various embodiments presented herein can utilize various AI/ML model/technology/technique/architecture (e.g., process component 178 implementing processes 179A-n). AI/ML technologies and techniques can be configured to determine information, make inferences, predictions, etc., regarding one or more conditions of an operational environment 150A-n on health of an entity (e.g., person 108) and/or operation of one or more components, etc., onboard a vehicle 102.

Processes 179A-n can include AI, ML, and reasoning techniques/technologies that employ probabilistic and/or statistical-based analysis to prognose or infer an action that an entity desires to be automatically performed for carrying out various aspects thereof, e.g., determining safe/unsafe operational environment at a location of a vehicle 102, e.g., fumes 150A-n in a garage 105, and one or more actions 162A-n to be performed as a function of the operational environment of vehicle 102 and location of entity 108, and suchlike, which as mentioned, can be facilitated via an automatic classifier system and process.

As used herein, the terms “predict”, “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis to prognose or infer an action that a user desires to be automatically performed (e.g., detection and mitigation of unsafe operating conditions 150A-n, warning an entity 108, relocation of vehicle 102, and suchlike).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (as further described below). For example, SVM's are configured via a learning or training phase within a classifier constructor and feature selection module, e.g., included in process component 178. Thus, the classifier(s) can be used to automatically learn and perform a number of functions, including but not limited to determining according to predetermined criteria, e.g., determining an environmental condition (e.g., per measurements 125A-n), potential effect of the environmental condition (e.g., per thresholds 161A-n), potential action (e.g., actions 162A-n) to address the environmental condition and potential effect on health of entity 108 and/or operation of vehicle 102, and suchlike.

In an example embodiment, processes 179A-n can be trained/fine-tuned with previously obtained/generated data (e.g., in historical data 189A-n, prior measurements 125A-n, prior implemented actions 162A-n, prior implemented/activated thresholds 161A-n). Fine-tuning of a process 179A-n can comprise application, to processes 179A-n, of prior measurements 125A-n, prior implemented actions 162A-n) prior implemented/activated thresholds 161A-n, prior health information 106A-n, etc., in historical data 189A-n, analysis of the prior measurements 125A-n and prior implemented/activated thresholds 161A-n/prior implemented actions 162A-n and suchlike, effectiveness of prior mitigation of one or more effects of environmental conditions 150A-n, and suchlike. Processes 179A-n can be correspondingly adjusted by the ability of the processes 179A-n (and analysis component 140) to successfully/or unsuccessfully mitigation of one or more effects of environmental conditions 150A-n. For example, weightings in the process 179A-n are adjusted by application of the ability to effectively/efficiently address the one or more effects of environmental conditions 150A-n. During training, prior decisions, prior observations, determinations, etc., can be applied to the processes 179A-n, enabling the processes 179A-n to be trained regarding mitigation of one or more effects of environmental conditions 150A-n. Accordingly, when new information is provided (e.g., processing of subsequent measurements 125A-n, subsequently implemented actions 162A-n, subsequently implemented/activated thresholds 161A-n), processes 179A-n can be retrained accordingly.

Accordingly, when mitigation of an environmental condition 150A-n is to be performed, AQS 110/process component 178 can be configured to:
(a) utilize one or more pertinent processes 179A-n,
(b) apply/compare current environmental conditions 150A-n (e.g., per current measurements 125A-n) with the prior conditions (e.g., generated from prior measurements 125A-n, historical data 189A-n), and
(c) generate a threshold 161A-n and/or an action 162A-n to implement to address current environmental conditions 150A-n.

Similarly, an inference can be made by processes 179A-n regarding effectiveness of addressing/mitigating the environmental condition 150A-n.

As previously mentioned, process component 178 can be utilized to implement processes 179A-n in conjunction with any of the components included in AQS 110.

It is to be appreciated that the various processes 179A-n and operations presented herein are simply examples of respective AI and ML operations and techniques, and any suitable technology can be utilized in accordance with the various embodiments presented herein. In an example embodiment, process component 178/processes 179A-n can be applied to any of entity information 106A-n, measurements 125A-n, actions 162A-n, thresholds 161A-n, historical data 189A-n, and suchlike. Wherein, process component 178/processes 179A-n can include a vector component to apply any suitable vectoring technology, such as, in a non-limiting list, bag of words (BOW) text vectors, Euclidean distance, cosine similarity, vector representation via term frequency-inverse document frequency (tf-idf) capturing term/token frequency (e.g., common terms across prior/current/future knowledge), neural network embedding layer vector representation of terms/categories (e.g., common terms having different tense), a transformer neural network, bidirectional and auto-regressive transformer (BART) model architecture, a bidirectional encoder representation from transformers (BERT) model, long short term memory network (LSTM) operation(s), a sentence state LSTM (S-LSTM), a deep learning algorithm, a sequential neural network, a sequential neural network that enables persistent information, a recurrent neural network (RNN), a convolutional neural network (CNN), a neural network, capsule network, a machine learning algorithm, a natural language processing (NLP) technique, sentiment analysis, bidirectional LSTM (BiLSTM), stacked BiLSTM, regular pattern expression matching, and suchlike. Language models, LSTMs, BARTs, etc., can be formed with a neural network that is highly complex, for example, comprising billions of weighted parameters.

Accordingly, in an embodiment, implementation of AQS 110 and included/associated components, with processes 179A-n, enables natural language processing (NLP) (e.g., utilizing vectors) to determine any of a threshold 161A-n and/or an action 162A-n to implement regarding an environmental condition 150A-n and/or a measurement 125A-n regarding health of an entity 108 and/or operation of vehicle 102, wherein the determined threshold 161A-n and/or an action 162A-n can be presented on HMI 186/screen 187A-n for review, and further, for use by analysis component 140.

During application of processes 179A-n, vector representations V₁₋ₙ can be applied to any of prior and current measurements 125A-n, such that vector similarity operations (e.g., vector clustering/distancing) can be applied to generate a proposed action 162A-n from the accrued prior knowledge regarding prior measurements 125A-n, per historical data 189A-n, and suchlike, regarding an environmental condition and potential effect on health of entity 108 and/or operation of vehicle 102, and suchlike. The degree of similarity (e.g., via similarity indexes S₁₋ₙ) between respective information can be determined, for example, based on a threshold reflecting a proximity of a first vector generated from information pertaining to a first measurement 125A and a second vector pertaining to a second measurement 125X (e.g., in historical data 189A-n), enabling ranking of potential actions 162A-n to implement, thresholds 161A-n to utilize, and the like.

It is to be appreciated that while any of analysis component 140, vehicle operation components 142, process component 178, and suchlike, can function as separate components/implemented independently, the respective components and functionality can be combined into a single component, such as analysis component 140 operating as a single, high-level component, with one or more of vehicle operation components 142, process component 178, and suchlike.

### Example Applications and Use

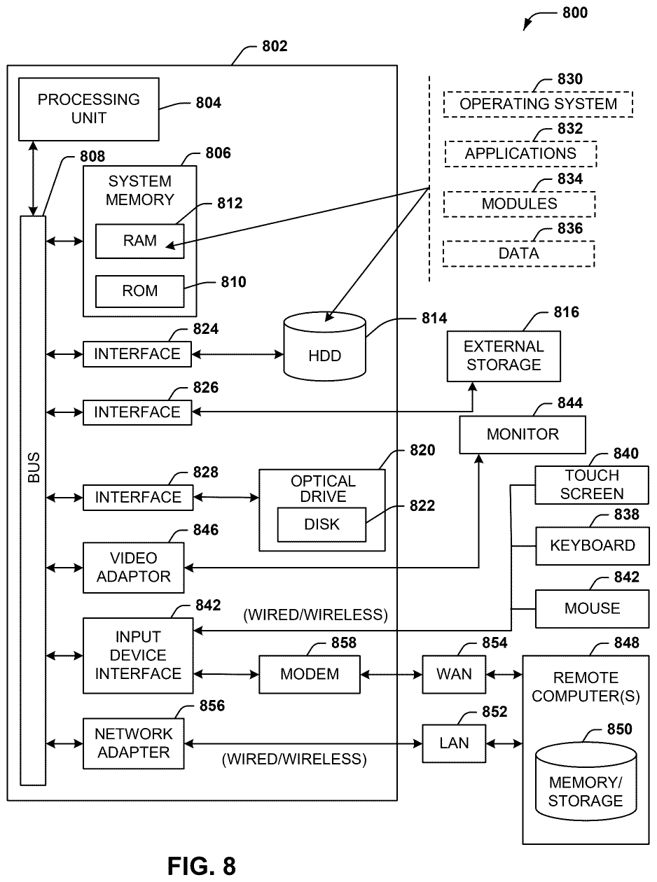

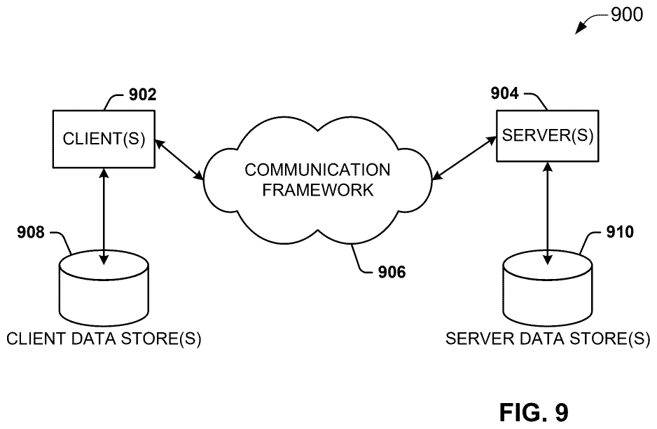

In order to provide a context for the various aspects of the disclosed subject matter, FIGS. 8 and 9 as well as the following discussion are intended to provide a brief, general description of a suitable environment in which the various aspects of the disclosed subject matter may be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 8 the example environment 800 for implementing various embodiments of the aspects described herein includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures can also be employed as the processing unit 804.

The system bus 808 can be any of several types of bus structure that can further interconnect to a memory bus (with or without a memory controller), a peripheral bus, and a local bus using any of a variety of commercially available bus architectures. The system memory 806 includes ROM 810 and RAM 812. A basic input/output system (BIOS) can be stored in a non-volatile memory such as ROM, erasable programmable read only memory (EPROM), EEPROM, which BIOS contains the basic routines that help to transfer information between elements within the computer 802, such as during startup. The RAM 812 can also include a high-speed RAM such as static RAM for caching data.

The computer 802 further includes an internal hard disk drive (HDD) 814 (e.g., EIDE, SATA), one or more external storage devices 816 (e.g., a magnetic floppy disk drive (FDD) 816, a memory stick or flash drive reader, a memory card reader, etc.) and an optical disk drive 820 (e.g., which can read or write from a CD-ROM disc, a DVD, a BD, etc.). While the internal HDD 814 is illustrated as located within the computer 802, the internal HDD 814 can also be configured for external use in a suitable chassis (not shown). Additionally, while not shown in environment 800, a solid state drive (SSD) could be used in addition to, or in place of, an HDD 814. The HDD 814, external storage device(s) 816 and optical disk drive 820 can be connected to the system bus 808 by an HDD interface 824, an external storage interface 826 and an optical drive interface 828, respectively. The interface 824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 812, including an operating system 830, one or more application programs 832, other program modules 834 and program data 836. All or portions of the operating system, applications, modules, and/or data can also be cached in the RAM 812. The systems and methods described herein can be implemented utilizing various commercially available operating systems or combinations of operating systems.

Computer 802 can optionally comprise emulation technologies. For example, a hypervisor (not shown) or other intermediary can emulate a hardware environment for operating system 830, and the emulated hardware can optionally be different from the hardware illustrated in FIG. 8. In such an embodiment, operating system 830 can comprise one virtual machine (VM) of multiple VMs hosted at computer 802. Furthermore, operating system 830 can provide runtime environments, such as the Java runtime environment or the .NET framework, for application programs 832. Runtime environments are consistent execution environments that allow application programs 832 to run on any operating system that includes the runtime environment. Similarly, operating system 830 can support containers, and application programs 832 can be in the form of containers, which are lightweight, standalone, executable packages of software that include, e.g., code, runtime, system tools, system libraries and settings for an application.

Further, computer 802 can be enable with a security module, such as a trusted processing module (TPM). For instance with a TPM, boot components hash next in time boot components, and wait for a match of results to secured values, before loading a next boot component. This process can take place at any layer in the code execution stack of computer 802, e.g., applied at the application execution level or at the operating system (OS) kernel level, thereby enabling security at any level of code execution.

A user can enter commands and information into the computer 802 through one or more wired/wireless input devices, e.g., a keyboard 838, a touch screen 840, and a pointing device, such as a mouse 842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 804 through an input device interface 844 that can be coupled to the system bus 808, but can be connected by other interfaces, such as a parallel port, an IEEE 1394 serial port, a game port, a USB port, an IR interface, a BLUETOOTH® interface, etc.

A monitor 844 or other type of display device can be also connected to the system bus 808 via an interface, such as a video adapter 846. In addition to the monitor 844, a computer typically includes other peripheral output devices (not shown), such as speakers, printers, etc.

The computer 802 can operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which can connect to a global communications network, e.g., the Internet.

When used in a LAN networking environment, the computer 802 can be connected to the local network 852 through a wired and/or wireless communication network interface or adapter 856. The adapter 856 can facilitate wired or wireless communication to the LAN 852, which can also include a wireless access point (AP) disposed thereon for communicating with the adapter 856 in a wireless mode.

When used in a WAN networking environment, the computer 802 can include a modem 858 or can be connected to a communications server on the WAN 854 via other means for establishing communications over the WAN 854, such as by way of the Internet. The modem 858, which can be internal or external and a wired or wireless device, can be connected to the system bus 808 via the input device interface 842. In a networked environment, program modules depicted relative to the computer 802 or portions thereof, can be stored in the remote memory/storage device 850. It will be appreciated that the network connections shown are example and other means of establishing a communications link between the computers can be used.

When used in either a LAN or WAN networking environment, the computer 802 can access cloud storage systems or other network-based storage systems in addition to, or in place of, external storage devices 816 as described above. Generally, a connection between the computer 802 and a cloud storage system can be established over a LAN 852 or WAN 854 e.g., by the adapter 856 or modem 858, respectively. Upon connecting the computer 802 to an associated cloud storage system, the external storage interface 826 can, with the aid of the adapter 856 and/or modem 858, manage storage provided by the cloud storage system as it would other types of external storage. For instance, the external storage interface 826 can be configured to provide access to cloud storage sources as if those sources were physically connected to the computer 802.

The computer 802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 9 is a schematic block diagram of a sample computing environment 900 with which the disclosed subject matter can interact. The sample computing environment 900 includes one or more client(s) 902. The client(s) 902 can be hardware and/or software (e.g., threads, processes, computing devices). The sample computing environment 900 also includes one or more server(s) 904. The server(s) 904 can also be hardware and/or software (e.g., threads, processes, computing devices). The servers 904 can house threads to perform transformations by employing one or more embodiments as described herein, for example. One possible communication between a client 902 and servers 904 can be in the form of a data packet adapted to be transmitted between two or more computer processes. The sample computing environment 900 includes a communication framework 906 that can be employed to facilitate communications between the client(s) 902 and the server(s) 904. The client(s) 902 are operably connected to one or more client data store(s) 908 that can be employed to store information local to the client(s) 902. Similarly, the server(s) 904 are operably connected to one or more server data store(s) 910 that can be employed to store information local to the servers 904.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

Various non-limiting aspects of various embodiments described herein are presented in the following clauses:

Clause 1. A system, located onboard a vehicle, comprising: at least one processor; and a memory coupled to the at least one processor and having instructions stored thereon, wherein, in response to the at least one processor executing the instructions, the instructions facilitate performance of operations, comprising: analyzing a measurement received from a sensor, wherein the sensor is configured to measure an environmental condition pertaining to the vehicle; based on analysis of the measurement, identifying a threshold pertaining to the measurement; and in response to determining the measurement is equal to or exceeds a value defined for the threshold, implementing an action defined for the threshold, wherein the action is configured to mitigate an effect of the environmental condition.

Clause 2. The system of any preceding clause, wherein the sensor is located onboard the vehicle or is located remotely from the vehicle.

Clause 3. The system of any preceding clause, wherein the sensor is located on an interior surface of the vehicle and is configured to measure an environmental condition of an interior space of the vehicle or the sensor is located on an exterior surface of the vehicle and is configured to measure an environmental condition of a location of the vehicle.

Clause 4. The system of any preceding clause, wherein the action is one of close a window located onboard the vehicle, open a window located on board the vehicle, terminate operation of the vehicle, relocate the vehicle, instruct a remotely located door to open, instruct a remotely located door to close, instruct a remotely located window to open, instruct a remotely located window to close, or notify an entity of the environmental condition.

Clause 5. The system of any preceding clause, wherein the environmental condition is represented by one of a chemical, a gas, a liquid, a solid, pollution, a particulate, a pathogen, a pesticide, a perfluoroalkyl substance, and a polyfluoroalkyl substance, a carcinogen, toxic material, radiation, a heat index, or a temperature.

Clause 6. The system of any preceding clause, wherein a given amount of the chemical in the environment is injurious to human health.

Clause 7. The system of any preceding clause, wherein the operations further comprise: receiving a parameter regarding at least one of an age or medical condition of an occupant of the vehicle; identifying a threshold configured for the at least one of age or medical condition of the occupant; and implementing the threshold as the threshold against which the measurement analysis is performed.

Clause 8. The system of any preceding clause, wherein the vehicle is configured to operate autonomously.

Clause 9. The system of any preceding clause, wherein the vehicle is located at a first location and the action comprises automatically relocating the vehicle to a second location, wherein the second location is remote from the first location.

Clause 10. The system of any preceding clause, wherein the action comprises: transmitting an instruction to a system remotely located to the vehicle, wherein the remotely located system is configured to control operation of at least one of a door, a window, a fenestration component, a fan, or a vent, located in a structure at the location at which the vehicle is parked, wherein the instruction is a command for the remotely located system to open or close the door, the window, the fenestration component, or the vent, or a command to start operation of the fan or terminate operation of the fan.

Clause 11. A computer-implemented method comprising: analyzing, by a device comprising at least one processor, a measurement received from a sensor regarding an operational environment of a vehicle, wherein the device is located on the vehicle and the measurement comprises a chemical measurement or a temperature measurement; comparing, by the device, the measurement with a threshold, wherein the threshold has a defined action; and in response to a determination, by the device, that the measurement exceeds the threshold, implementing the action defined for the threshold, wherein the action is configured to mitigate an effect of the environmental condition.

Clause 12. The computer-implemented method of any preceding clause, wherein the chemical measurement represents presence of at least one of a chemical, a gas, a liquid, a solid, pollution, a particulate, a pathogen, a pesticide, a perfluoroalkyl substance, a polyfluoroalkyl substance, a carcinogen, toxic material, or radiation, and the temperature measurement represents one of a heat index or a temperature.

Clause 13. The computer-implemented method of any preceding clause, wherein the measurement is a first measurement, the threshold is a first threshold, and the action is a first action, the method further comprising: receiving, by the device, subsequent to implementing the first action, a second measurement from the sensor; comparing, by the device, the second measurement with a second threshold, wherein the second threshold has a defined second action, and the second threshold is disparate to the first threshold; and in response to a determination, by the device, that the second measurement exceeds the second threshold, implementing the second action defined for the second threshold.

Clause 14. The computer-implemented method of any preceding clause, wherein the first action comprises generating an alert and the second action comprises one of closing a window located onboard the vehicle, opening a window located on board the vehicle, terminating operation of the vehicle, relocating the vehicle, instructing a remotely located door to open, instructing a remotely located door to close, instructing a remotely located window to open, instructing a remotely located window to close, or notifying an emergency service of operational environment.

Clause 15. The computer-implemented method of any preceding clause, wherein the sensor is: located onboard the vehicle on an interior surface of the vehicle and is configured to measure an environmental condition of an interior space of the vehicle or the sensor is located on an exterior surface of the vehicle and is configured to measure a condition of an environment external to the vehicle, or the sensor is located remotely from the vehicle.

Clause 16. The computer-implemented method of any preceding clause, wherein the vehicle is located at a first location and the vehicle is further configured to operate autonomously, wherein the action comprises relocating the vehicle to a second location, wherein the second location is remote from the first location.

Clause 17. A computer program product comprising a computer readable storage medium having program instructions embodied therewith, the program instructions executable by a processor located on a vehicle, to cause the processor to: analyze a measurement received from a sensor, wherein the sensor is configured to measure a condition of an environment pertaining to the vehicle, wherein the environment pertains to a passenger compartment of the vehicle or the environment pertains to an environment external to the vehicle; based on analysis of the measurement, identify a threshold having a defined value exceeded by the measurement; and in response to a determination that the measurement exceeds the value defined for the threshold, implement an action defined for the threshold, wherein the action is configured to mitigate an effect of the environmental condition.

Clause 18. The computer program product of any preceding clause, wherein the sensor is configured to measure at least one of presence of a chemical, a gas, a liquid, a solid, pollution, a particulate, a pathogen, a pesticide, a perfluoroalkyl substance, a polyfluoroalkyl substance, a carcinogen, toxic material, radiation, a temperature, or a heat index.

Clause 19. The computer program product of any preceding clause, wherein the action is one of close a window located onboard the vehicle, open a window located on board the vehicle, terminate operation of the vehicle, relocate the vehicle, instruct a remotely located door to open, instruct a remotely located door to close, instruct a remotely located window to open, instruct a remotely located window to close, notify an entity of the environmental condition, notify an emergency service, or notify a crisis hotline.

Claim 20. The computer program product of any preceding clause, wherein the vehicle is operating autonomously and the vehicle is located at a first location, wherein the action comprises automatically relocating the vehicle to a second location, wherein the second location is remote from the first location.

In various cases, any suitable combination of clauses 1-10 can be implemented.

In various cases, any suitable combination of clauses 11-16 can be implemented.

In various cases, any suitable combination of clauses 17-20 can be implemented.

What is claimed is:

1. A system, located onboard a vehicle, comprising:
at least one processor; and
a memory coupled to the at least one processor and having instructions stored thereon, wherein, in response to the at least one processor executing the instructions, the instructions facilitate performance of operations, comprising:
analyzing a measurement received from a sensor, wherein the sensor is configured to measure an environmental condition pertaining to the vehicle;
based on analysis of the measurement, identifying a threshold pertaining to the measurement; and
in response to determining the measurement is equal to or exceeds a value defined for the threshold, implementing an action defined for the threshold, wherein the action is configured to mitigate an effect of the environmental condition.

2. The system of claim 1, wherein the sensor is located onboard the vehicle or is located remotely from the vehicle.

3. The system of claim 2, wherein the sensor is located on an interior surface of the vehicle and is configured to measure an environmental condition of an interior space of the vehicle or the sensor is located on an exterior surface of the vehicle and is configured to measure an environmental condition of a location of the vehicle.

4. The system of claim 1, wherein the action is one of close a window located onboard the vehicle, open a window located on board the vehicle, terminate operation of the vehicle, relocate the vehicle, instruct a remotely located door to open, instruct a remotely located door to close, instruct a remotely located window to open, instruct a remotely located window to close, or notify an entity of the environmental condition.

5. The system of claim 1, wherein the environmental condition is represented by one of a chemical, a gas, a liquid, a solid, pollution, a particulate, a pathogen, a pesticide, a perfluoroalkyl substance, and a polyfluoroalkyl substance, a carcinogen, toxic material, radiation, a heat index, or a temperature.

6. The system of claim 5, wherein a given amount of the chemical in the environment is injurious to human health.

7. The system of claim 1, wherein the operations further comprise:
receiving a parameter regarding at least one of an age or medical condition of an occupant of the vehicle;
identifying a threshold configured for the at least one of age or medical condition of the occupant; and
implementing the threshold as the threshold against which the measurement analysis is performed.

8. The system of claim 1, wherein the vehicle is configured to operate autonomously.

9. The system of claim 8, wherein the vehicle is located at a first location and the action comprises automatically relocating the vehicle to a second location, wherein the second location is remote from the first location.

10. The system of claim 1, wherein the action comprises:
transmitting an instruction to a system remotely located to the vehicle, wherein the remotely located system is configured to control operation of at least one of a door, a window, a fenestration component, a fan, or a vent, located in a structure at the location at which the vehicle is parked, wherein the instruction is a command for the remotely located system to open or close the door, the window, the fenestration component, or the vent, or a command to start operation of the fan or terminate operation of the fan.

11. A computer-implemented method comprising:
analyzing, by a device comprising at least one processor, a measurement received from a sensor regarding an operational environment of a vehicle, wherein the device is located on the vehicle and the measurement comprises a chemical measurement or a temperature measurement;
comparing, by the device, the measurement with a threshold, wherein the threshold has a defined action; and
in response to a determination, by the device, that the measurement exceeds the threshold, implementing the action defined for the threshold, wherein the action is configured to mitigate an effect of the environmental condition.

12. The computer-implemented method of claim 11, wherein the chemical measurement represents presence of at least one of a chemical, a gas, a liquid, a solid, pollution, a particulate, a pathogen, a pesticide, a perfluoroalkyl substance, a polyfluoroalkyl substance, a carcinogen, toxic material, or radiation, and the temperature measurement represents one of a heat index or a temperature.

13. The computer-implemented method of claim 11, wherein the measurement is a first measurement, the threshold is a first threshold, and the action is a first action, the method further comprising:
receiving, by the device, subsequent to implementing the first action, a second measurement from the sensor;
comparing, by the device, the second measurement with a second threshold, wherein the second threshold has a defined second action, and the second threshold is disparate to the first threshold; and
in response to a determination, by the device, that the second measurement exceeds the second threshold, implementing the second action defined for the second threshold.

14. The computer-implemented method of claim 13, wherein the first action comprises generating an alert and the second action comprises one of closing a window located onboard the vehicle, opening a window located on board the vehicle, terminating operation of the vehicle, relocating the vehicle, instructing a remotely located door to open, instructing a remotely located door to close, instructing a remotely located window to open, instructing a remotely located window to close, or notifying an emergency service of operational environment.

15. The computer-implemented method of claim 11, wherein the sensor is:
located onboard the vehicle on an interior surface of the vehicle and is configured to measure an environmental condition of an interior space of the vehicle or the sensor is located on an exterior surface of the vehicle and is configured to measure a condition of an environment external to the vehicle, or
the sensor is located remotely from the vehicle.

16. The computer-implemented method of claim 11, wherein the vehicle is located at a first location and the vehicle is further configured to operate autonomously, wherein the action comprises relocating the vehicle to a second location, wherein the second location is remote from the first location.

17. A computer program product comprising a computer readable storage medium having program instructions embodied therewith, the program instructions executable by a processor located on a vehicle, to cause the processor to:
analyze a measurement received from a sensor, wherein the sensor is configured to measure a condition of an environment pertaining to the vehicle, wherein the environment pertains to a passenger compartment of the vehicle or the environment pertains to an environment external to the vehicle;
based on analysis of the measurement, identify a threshold having a defined value exceeded by the measurement; and
in response to a determination that the measurement exceeds the value defined for the threshold, implement an action defined for the threshold, wherein the action is configured to mitigate an effect of the environmental condition.

18. The computer program product according to claim 17, wherein the sensor is configured to measure at least one of presence of a chemical, a gas, a liquid, a solid, pollution, a particulate, a pathogen, a pesticide, a perfluoroalkyl substance, a polyfluoroalkyl substance, a carcinogen, toxic material, radiation, a temperature, or a heat index.

19. The computer program product according to claim 17, wherein the action is one of close a window located onboard the vehicle, open a window located on board the vehicle, terminate operation of the vehicle, relocate the vehicle, instruct a remotely located door to open, instruct a remotely located door to close, instruct a remotely located window to open, instruct a remotely located window to close, notify an entity of the environmental condition, notify an emergency service, or notify a crisis hotline.

20. The computer program product according to claim 17, wherein the vehicle is operating autonomously and the vehicle is located at a first location, wherein the action comprises automatically relocating the vehicle to a second location, wherein the second location is remote from the first location.
